(19) United States
(12) Patent Application Publication
(10) Pub. No.: US 2026/0104022 A1
(43) Pub. Date: Apr. 16, 2026

(54) ENGINE

(71) Applicant: TOYOTA JIDOSHA KABUSHIKI KAISHA, Toyota-shi (JP)

(72) Inventors: Takashi KOBAYASHI, Toyota-shi (JP); Yasuki SENOO, Toyota-shi (JP)

(73) Assignee: TOYOTA JIDOSHA KABUSHIKI KAISHA, Toyota-shi (JP)

(21) Appl. No.: 19/333,576

(22) Filed: Sep. 19, 2025

(30) Foreign Application Priority Data
Oct. 16, 2024 (JP) 2024-180849

(51) Int. Cl. F02M 35/10; B60K 5/02; F02B 29/04; F02M 35/104

(52) U.S. Cl. CPC F02M 35/10157; B60K 5/02; F02B 29/0462; F02M 35/104

(57) ABSTRACT

An engine includes a body including a crankshaft, an intake manifold connected to a side surface of the body on an intake side, an intake pipe connected to the intake manifold, a compressor of a supercharger provided in the intake pipe, and an intercooler of a water-cooled type provided in the intake pipe and provided downstream of the compressor. The intercooler is provided along a front side surface of the body intersecting with an axis of the crankshaft.

### CROSS-REFERENCE TO RELATED APPLICATION

This application is based upon and claims the benefit of priority of the prior Japanese Patent Application No. 2024-180849, filed on October 16, 2024, the entire contents of which are incorporated herein by reference.

### TECHNICAL FIELD

The present disclosure relates to an engine.

### BACKGROUND

There is a configuration in which an intercooler is disposed on a side surface on an intake side of a body of an engine (for example, refer to Japanese Unexamined Patent Application Publication No. Hei 08-210140).

In the engine described above, the intercooler is disposed on a side surface of an intake side, and thus the engine is increased in size in a width direction intersecting an axis of the crankshaft.

### SUMMARY

It is therefore an object of the present disclosure to provide an engine that is reduced in size in a width direction intersecting an axis of a crankshaft.

The above object is achieved by an engine including; a body including a crankshaft; an intake manifold connected to a side surface of the body on an intake side; an intake pipe connected to the intake manifold; a compressor of a supercharger provided in the intake pipe; and an intercooler of a water-cooled type provided in the intake pipe and provided downstream of the compressor, wherein the intercooler is provided along a front side surface of the body intersecting with an axis of the crankshaft.

The intercooler may be shaped such that a thickness of the intercooler in a direction of the axis of the crankshaft is smaller than a size of the intercooler in a direction orthogonal to the direction of the axis.

A length of the intake pipe from the compressor to the intercooler may be shorter than a length of the intake pipe from the intercooler to the intake manifold.

The body may include a camshaft, and the intercooler may be disposed at a position higher than the crankshaft and lower than the camshaft when viewed from the front side surface.

The body may be mounted on a vehicle such that the direction of the axis of the crankshaft is along a front-rear direction of the vehicle.

### BRIEF DESCRIPTION OF THE DRAWINGS

FIG. 1 is a schematic configuration view of a vehicle equipped with an engine; and

FIG. 2A is a front view of the engine according to a present embodiment, FIG. 2B is a side view of the engine according to the present embodiment, and FIG. 2C is an explanatory view of an engine of a comparative example.

### DETAILED DESCRIPTION

### [Schematic Configuration of Vehicle]

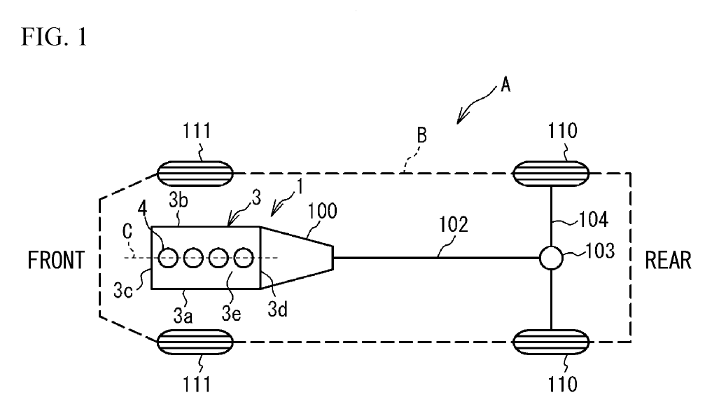

FIG. 1 is a schematic configuration view of a vehicle A equipped with an engine 1. The vehicle A includes a vehicle body B, the engine 1, a transmission 100, a propeller shaft 102, a differential gear 103, a drive shaft 104, drive wheels 110, and driven wheels 111. The engine 1 is an in-line engine having four cylinders 4. A direction in which the four cylinders 4 are arranged is the same as a direction of an axis C of a crankshaft of the engine 1. The axis C is along the front-rear direction of the vehicle A. The engine 1 is disposed in an engine compartment at the front of the vehicle A.

The power of the engine 1 is transmitted to the drive wheels 110 via the transmission 100, the propeller shaft 102, the differential gear 103, and the drive shaft 104. The drive wheels 110 correspond to rear wheels, and the driven wheels 111 correspond to front wheels. The engine 1 includes a body 3. The body 3 includes an intake side surface 3a, an exhaust side surface 3b, a front side surface 3c, a rear side surface 3d, and a top side surface 3e. The intake side surface 3a faces a left side of the vehicle A and is connected to an intake manifold described later. The exhaust side surface 3b faces a right side of the vehicle A and is connected to an exhaust manifold. The front side surface 3c faces a front side of the vehicle A. The rear side surface 3d faces a rear side of the vehicle A, and the transmission 100 is disposed on the rear surface SL. The top side surface 3e faces upward in the vehicle A. Next, the engine 1 will be described in detail.

### [Schematic Configuration of Engine]

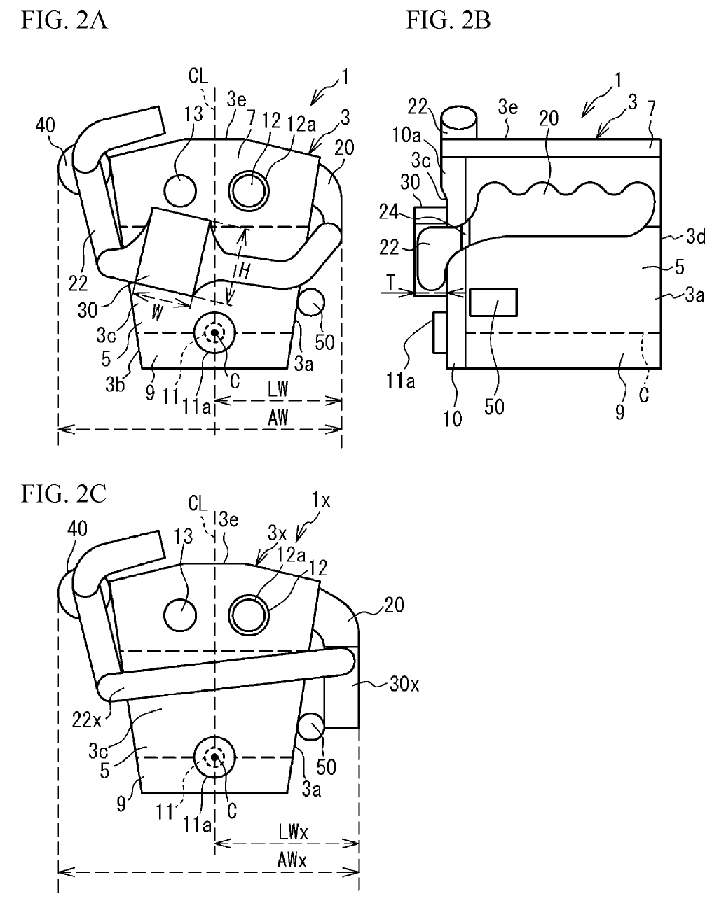

FIG. 2A is a front view of the engine 1 according to the present embodiment. FIG. 2B is a side view of the engine 1 according to the present embodiment. FIG. 2C is a front view of an engine 1x of a comparative example. FIG. 2A is a view of the engine 1 as viewed from the front side surface 3c. FIG. 2B is a view of the engine 1 as viewed from the intake side surface 3a. FIG. 2C is a view of the engine 1 of the comparative example as viewed from the front side surface 3c. In FIGS. 2A and 2C, a center line CL passing through the axis C and parallel to a vertical direction is illustrated. In FIGS. 2A and 2C, an exhaust manifold and an exhaust passage are not illustrated. First, the engine 1 according to the present embodiment will be described. The body 3 includes a cylinder block 5, a cylinder head 7, an oil pan 9, and a chain case 10. The cylinder head 7 is disposed on the cylinder block 5. The oil pan 9 is disposed below the cylinder block 5. The chain case 10 is disposed so as to cover the front surface side of the body 3. The chain case 10 accommodates a timing chain that interlocks a crankshaft 11, an intake camshaft 12, and an exhaust camshaft 13, which will be described later. A pulley 11a attached to a distal end of the crankshaft 11 protrudes from an opening formed in the chain case 10 toward the front side. The pulley 11a drives a pulley for auxiliary machines via a belt.

The crankshaft 11 is rotatably supported by the cylinder block 5 and the oil pan 9. The cylinder head 7 is provided with the intake camshaft 12 and the exhaust camshaft 13. The intake camshaft 12 rotates in conjunction with the rotation of the crankshaft 11 via a timing chain, and drives the intake valve of each cylinder 4. The exhaust camshaft 13 rotates in conjunction with the rotation of the crankshaft 11 via a timing chain, and drives the exhaust valve of each cylinder 4.

The intake camshaft 12 is provided on the intake side surface 3a side with respect to the center line CL. The intake camshaft 12 is provided with a variable valve mechanism 12a. The variable valve mechanism 12a is a mechanism that changes rotational phases of the crankshaft 11 and the intake camshaft 12 to change the opening and closing timing of the intake valves driven by the intake camshaft 12. The exhaust camshaft 13 is provided on the exhaust side surface 3b side with respect to the center line CL.

An intake manifold 20 is connected to the intake side surface 3a so as to communicate with intake ports. A water pump 50 is disposed in the cylinder block 5 below the intake manifold 20 on the intake side surface 3a. The water pump 50 circulates the cooling water in the body 3. An intake pipe 22 is connected to the intake manifold 20. As illustrated in FIG. 2B, a throttle valve 24 is provided in the intake pipe 22 before the intake manifold 20. The throttle valve 24 adjusts the amount of intake air introduced into the body 3 through the intake pipe 22. The intake pipe 22 extends from the intake manifold 20 to the front side surface 3c, the exhaust side surface 3b, and the top side surface 3e in this order. The intake pipe 22 is provided with a compressor 40 of a supercharger, an intercooler 30, and the above-described throttle valve 24 in this order from the upstream side to the downstream side. A turbine of the supercharger is disposed in the exhaust passage. The compressor 40 is rotated by the exhaust energy received by the turbine, and the intake air is supercharged.

The intercooler 30 is disposed along the front side surface 3c. The intercooler 30 has a shape in which a thickness T is smaller than a width W and smaller than a height H. The intercooler 30 is disposed such that the direction of the thickness T is the direction of the axis C. Therefore, the height H and the width W correspond to the size in the direction orthogonal to the axis C. The intercooler 30 is a water-cooled type, and improves intake efficiency by cooling intake air that has been supercharged by the compressor 40 and has become high in temperature. An introduction pipe and a discharge pipe for cooling water are connected to the intercooler 30, but are not illustrated. The inner diameter of the intake pipe 22 is increased on the intake side and the discharge side of the intake air to the intercooler 30.

As illustrated in FIG. 2C, in the engine 1x of the comparative example, an intercooler 30x is provided at a position of an intake pipe 22x close to the intake manifold 20. The intercooler 30x is disposed along the intake side surface 3a of a body 3x. Further, the intercooler 30x is disposed so as to overlap the water pump 50.

As illustrated in FIG. 2A, in the engine 1 according to the present embodiment, the intercooler 30 is disposed along the front side surface 3c. As illustrated in FIG. 2C, in the engine 1x of the comparative example, the intercooler 30x is disposed along the intake side surface 3a. Therefore, a length LW from the center line CL of the engine 1 to the intake manifold 20 is smaller than a length LWx from the center line CL of the engine 1x to the intake manifold 20. Therefore, a length AW from the compressor 40 to the intake manifold 20 in the engine 1 is smaller than a length AWx from the compressor 40 to the intake manifold 20 in the engine 1x. Thus, the engine 1 is reduced in size in the width direction intersecting the axis C. The engine 1 is mounted on the vehicle A such that the direction of the axis C is along the front-rear direction of the vehicle A. Therefore, it is possible to suppress an increase in the space occupied in the vehicle A in the width direction of the engine 1.

As described above, the intercooler 30 is shaped such that the thickness T in the direction of the axis C is smaller than the size in the direction orthogonal to the direction of the axis of the intercooler 30. Therefore, as illustrated in 2B of the drawing, the engine 1 is prevented from being increased in size in the direction of the axis C.

As illustrated in FIG. 2A, the intake pipe 22 from the compressor 40 to the intercooler 30 is shorter than the intake pipe 22 from the intercooler 30 to the intake manifold 20. In other words, the intercooler 30 is located on the exhaust side surface 3b with respect to the center line CL and is closer to the exhaust camshaft 13 than to the intake camshaft 12. In contrast, in the comparative example, the intake pipe 22x from the compressor 40 to the intercooler 30x is longer than the intake pipe 22x from the intercooler 30x to the intake manifold 20. Therefore, in the present embodiment, the intake air pressurized by the compressor 40 and having a high temperature is cooled by the intercooler 30 earlier than in the comparative example. Thus, in the present embodiment, the upper limit of the heat resistance of the intake pipe 22 and the intake manifold 20 downstream of the intercooler 30 is set lower than in the comparative example.

Further, when viewed from the front side surface 3c, the intercooler 30 is disposed at a position lower than the intake camshaft 12 and the exhaust camshaft 13 and higher than the crankshaft 11. For example, when the intercooler 30 overlaps at least one of the crankshaft 11, the intake camshaft 12, and the exhaust camshaft 13, the intake pipe 22 may be largely curved on the front side surface 3c and the intake pipe 22 may be long. In the present embodiment, the intake pipe 22 is prevented from becoming long as described above. This suppresses an increase in intake resistance.

As illustrated in FIG. 2B, a portion 10a of the chain case 10 corresponding to the variable valve mechanism 12a is thicker than the other portions in the direction of the axis C, and more specifically, is raised forward. This is to release the variable valve mechanism 12a. The intercooler 30 is thus disposed at a position lower than the variable valve mechanism 12a. For example, when the intercooler 30 is disposed so as to overlap the variable valve mechanism 12a in the direction of the axis C, the size of the engine 1 increases in the direction of the axis C. In the present embodiment, the intercooler 30 is disposed at a position lower than the variable valve mechanism 12a, and therefore, an increase in size of the engine 1 in the direction of the axis C is suppressed. Similarly, the intercooler 30 is provided at a position higher than the pulley 11a fixed to the crankshaft 11. As described above, the pulley 11a protrudes from the chain case 10 in the direction of the axis C. In the present embodiment, the intercooler 30 is disposed at a position higher than the pulley 11a, and therefore, an increase in size of the engine 1 in the direction of the axis C is suppressed.

In this embodiment, the vehicle A is a vehicle on which only the engine 1 is mounted as a traveling power source. However, the vehicle A may be a hybrid vehicle in which a motor is mounted in addition to the engine 1 as a traveling power source. Further, although the variable valve mechanism 12a is provided on the intake camshaft 12, the variable valve mechanism may be provided on the exhaust camshaft 13. Further, the variable valve mechanism may be provided only on the exhaust camshaft 13.

Although some embodiments of the present disclosure have been described in detail, the present disclosure is not limited to the specific embodiments but may be varied or changed within the scope of the present disclosure as claimed.

What is claimed is:

1. An engine comprising;
a body including a crankshaft;
an intake manifold connected to a side surface of the body on an intake side;
an intake pipe connected to the intake manifold;
a compressor of a supercharger provided in the intake pipe; and
an intercooler of a water-cooled type provided in the intake pipe and provided downstream of the compressor,
wherein the intercooler is provided along a front side surface of the body intersecting with an axis of the crankshaft.

2. The engine according to claim 1, wherein the intercooler is shaped such that a thickness of the intercooler in a direction of the axis of the crankshaft is smaller than a size of the intercooler in a direction orthogonal to the direction of the axis.

3. The engine according to claim 2, wherein a length of the intake pipe from the compressor to the intercooler is shorter than a length of the intake pipe from the intercooler to the intake manifold.

4. The engine according to claim 3,
wherein
the body includes a camshaft, and
the intercooler is disposed at a position higher than the crankshaft and lower than the camshaft when viewed from the front side surface.

5. The engine according to claim 1, wherein the body is mounted on a vehicle such that the direction of the axis of the crankshaft is along a front-rear direction of the vehicle.
